(19) United States
(12) Patent Application Publication
(10) Pub. No.: US 2006/0282626 A1
(43) Pub. Date: Dec. 14, 2006

(54) Memory device and method of controlling operation of the memory device

(76) Inventor: Alessandro Fin, Dresden (DE)

Correspondence Address: SLATER & MATSIL LLP, 17950 PRESTON ROAD, SUITE 1000, DALLAS, TX, 75252, US

(21) Appl. No.: 11/147,988

(22) Filed: Jun. 8, 2005

(51) Int. Cl. G06F 13/00; G06F 12/00

(52) U.S. Cl. 711/154; 711/103

(57) ABSTRACT

A memory device comprises a microcontroller, a error-tolerant repository with a rewritable section arranged to store program files and being associated with the microcontroller, and a memory array for storing data provided from an external source. A method for controlling operation of a memory device comprises receiving an event, loading a first program file stored in the memory array into a first section of the repository in response to the event, and executing the program file by the microcontroller in order to perform an operation of the memory device. The method and the device may advantageously be embodied in the field of flash memories.

### TECHNICAL FIELD

In one aspect, the invention relates to a memory device and a method for controlling operation of the memory device. Embodiments of the invention particularly relate to non-volatile memory devices, and more specifically to flash memory devices, which comprise a microcontroller, an error-tolerant repository and a memory array.

### BACKGROUND

Flash memory products have become increasingly important as storage media. Generally a flash memory device is divided into three main constituent parts: a microcontroller, which controls operation of the flash memory device; a repository, which is associated with the microcontroller and serving as a fast and error-tolerant storage area for program files to be executed by the microcontroller; and a memory array, which is arranged to receive and store any data that are provided externally. The microcontroller may be a state machine controlling the operation of the memory array.

The error-tolerant repository is a storage device, which has a size of typically 4 kb. In order to guarantee an error tolerance, an amount of 1 kb is reserved for program files, wherein this amount of 1 kb is repeated, e.g., four times within the repository. This redundancy preserves a read-disturb-free loading of binary code from the repository into the microcontroller.

The repository, the memory array and the microcontroller are typically integrated into one flash memory chip. Therein, the repository is arranged in direct association with the microcontroller, i.e., adjacent to the microcontroller, in order to save signal path length and loss of electrical currents. Area limitations require keeping this repository as small as possible. Replicating each byte four times implies a considerable area increment for each additional stored byte. This limited capacity thus leads to strong constraints when designing and developing larger software programs to be executed by the microcontroller. Such programs may relate, e.g., to self-test algorithms, which are built into the system as so-called BIST algorithms. In recent years such algorithms have started to replace the previously dominant ad-hoc ATE (automated test equipment) code, which has led to a considerable test cost reduction with respect to each single flash memory chip.

### SUMMARY OF THE INVENTION

Embodiments of the invention provide a flash memory device that does not suffer from capacity limitations with respect to the binary code repository, thus enabling an implementation of larger self-test algorithms.

Further embodiments of the invention reduce the costs and effort of testing a memory device.

One embodiment of the invention is a method for controlling operation of a memory device having a microcontroller, an error-tolerant repository arranged to store program files for execution by the microcontroller, and a memory array for storing data provided externally. The method comprises receiving an event, loading a first program file stored in the memory array into a first section of the repository in response to the event, and executing the program file by the microcontroller in order to perform an operation of the memory device.

Another embodiment of the invention is a memory device comprising a microcontroller for controlling operation of the memory device, a memory array being connected to the microcontroller for storing data that is received by the memory device from an external source, an error-tolerant repository connected to the microcontroller for storing program files to be executed by the microcontroller in order to perform testing, initialization or application of the memory device. The repository comprises a first section to be loaded with at least one first program file that can be deleted, unloaded or overwritten with at least one further program file by the microcontroller.

Conventional repositories associated with a microcontroller, which are of a read-only memory (ROM) type, are replaced by a repository, which has at least a section, wherein the binary code content can be dynamically deleted, overwritten or unloaded. Accordingly, program files that are to be executed in due course by a microcontroller can be loaded dynamically into the repository prior to their usage. Although the size of the repository may be arranged such as according to prior art, e.g., 4 kb including the four times redundancy, a considerably higher volume of binary code of program files is available for execution by the microcontroller in accordance with embodiments of the invention.

According to one embodiment of the invention, the load and/or unload mechanism into/from the repository is controlled by a software module kernel, which is stored in the repository in addition to the dynamically loaded program files. The storage of the software module kernel may be permanent, however, the invention is not limited thereto. In particular, the different sections of the repository may be logical adjacent segments. Thus, the repository may be arranged to be erasable even if only one portion of a section is actually erased, or overwritten by further binary code.

The software module kernel may reside in a section of the repository that is different from a section that receives the program files. This distinction helps guarantee that the software module kernel is not overwritten by further program files loaded into the repository.

This configuration thus provides some basic functionalities similar to an operative or operating system (OS) kernel for a memory design, for example a flash memory device, which hitherto have not been capable of supporting an embedded OS. While the prior art binary code executed by the microcontroller is related to a fixed, predetermined sequence of commands, the flash memory device according to a preferred embodiment of the invention may respond to the dynamically occurring events and requirements of the surroundings. In particular, the repository may be operated based on events that are generated from external sources, e.g., signals indicating performance of a self-test, or from internal sources, which may depend on a status of individual elements of the flash memory device.

In a preferred embodiment, the software module kernel, upon execution in a microcontroller, handles these events and is arranged to anticipatorily select specific program files in order to load these files into the repository prior to execution in the microcontroller. This loading may depend on the current mode of the flash memory device. For example, when a test mode is started there will be enough time to load the corresponding test program files into the repository and then execute the program file using the microcontroller. The software kernel is arranged to determine which program file is loaded into the repository.

According to a further embodiment, the advantageous concept of a rewritable program file section in combination with, e.g., a permanently stored software module kernel controlling operation of the microcontroller and the repository is further enhanced by a section of the repository that has permanently stored global variables. While the software module kernel may be standardized for a series of different memory devices, the global variables provide for the specific execution of the software kernel on a current memory device. The global variables serve to identify the current software module stored in the dynamic section of the repository, to select the next module or program file for dynamical loading, and to evaluate the event or trigger conditions for loading the next software module.

It is noted that the invention is not limited to flash memory devices. It will become clear to a person skilled in the art, that the method and the configuration of device components can as well be embodied with other types of memories, in particular static or nonvolatile memories, for example magnetic memories (MRAM), nano-crystal memories, etc.

The invention will become clearer with respect to certain embodiments when taken in conjunction with the accompanying drawings.

### DESCRIPTION OF THE DRAWINGS

For a more complete understanding of the present invention, and the advantages thereof, reference is now made to the following descriptions taken in conjunction with the accompanying drawing, in which:

FIG. 1 shows a flash memory device according to an embodiment of the invention;

FIG. 2 shows details of a repository according to an embodiment of the invention, which is arranged to be rewritable in a program file section; and

FIG. 3 shows a flow chart according to an embodiment of the invention.

The following list of reference symbols can be used in conjunction with the figures:
memory device, flash memory device
microcontroller
interface
repository
memory array (flash)
OTP area
(first) program file section (rewritable)
(third) global variable section (permanent)
(second) software module kernel section (permanent)
102 . . . 106 10n portions of OTP area to store program files permanently

### DETAILED DESCRIPTION OF ILLUSTRATIVE EMBODIMENTS

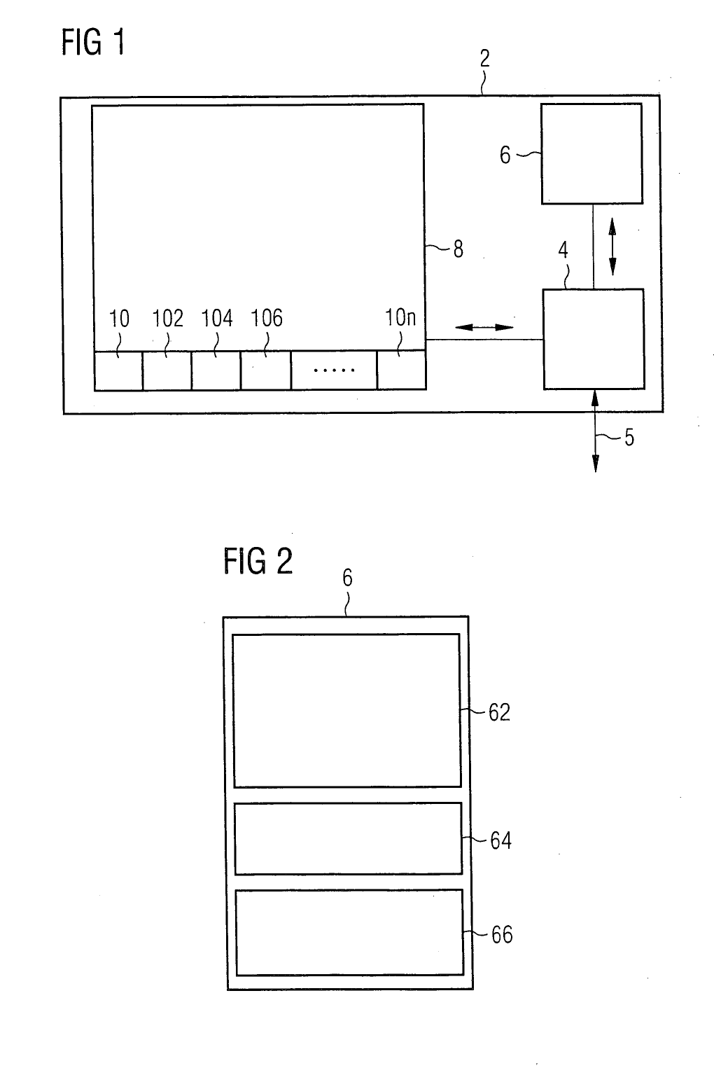

FIG. 1 shows an embodiment of the present invention. A flash memory device 2 comprises a repository 6 that is associated with a microcontroller 4. The microcontroller 4 has an interface 5 that may connect to an external data or signal source in order to achieve transfer of data to be stored or read out or to communicate with an external test device, etc.

The microcontroller 4 further operates storage of data in a flash memory array 8, that is based on charge trapping cells and may be of the NAND or NOR-type. The size of the memory 8 may have a wide range adapted to the particular use of the flash device, e.g., 64 Mb with respect to an arbitrary MMC card.

The repository 6 may be, among other options, of the SRAM type (static RAM), DRAM type (dynamic random access memory) or even the flash type as well. It may have a size of 4 kb with a four times redundancy in order to provide an amount of error tolerance. In other words, each bit of the binary code stored in the repository 6 is repeated four times in different locations of the repository.

The memory array 8 mainly consists of a rewritable storage area and further of an OTP (One Time Programming) area 10. The OTP area represents a section of the memory array 8.

The OTP areas of conventional flash memory devices typically have sizes of about 100 kb—a size that has in previous applications been widely unused. In that OTP area of conventional flash memory devices, permanently stored information about the memory array for testing and boot purposes, e.g., information about the size of the array, the manufacturer, etc., is made available, thereby consuming roughly 0.1% of the storage area. According to a preferred embodiment of the invention, the OTP area is subdivided into portions 102, 104, 106, . . . , 10n for receiving program files, i.e., binary code is stored in the OTP area 10 of the memory array 8, while user specific data are stored in the rest of memory array 8.

Each portion receives a program file to be executed on a certain event during initialization or operation of the flash device. For example, portion 102 contains a boot sequence, portion 104 contains in-operation self-check code, portion 106 contains built-in self-test (BIST) binary code to be executed during or after manufacturing of the device, etc.

FIG. 2 shows details of the repository 6. It comprises sections 62, 64 and 66 arranged to rewritable or permanent information. A first section 62 receives program files to be executed by the microcontroller and is rewritable for this purpose. A second section 66 stores the software module kernel, which performs tasks similar to an embedded OS. This section 66 is arranged to be write-protected, i.e., read-only.

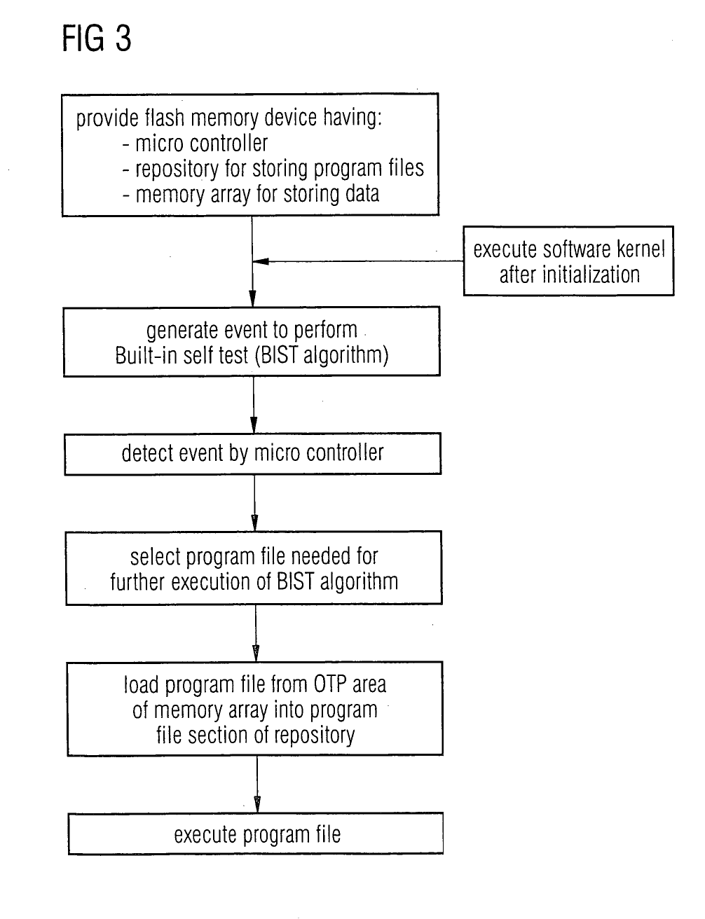

As shown in the flow chart of FIG. 3, the software module kernel is read out from the repository 6 first, or more precisely from section 66, and executed by the microcontroller 4. Further, global variables permanently written to a third repository section 64 may be read out, by which the program flow due to the software module kernel is configured for the present application.

The software module kernel residing in the second section 66 has the advantage that it may be released for a series of flash memory device products and can be configured for specific applications by means of setting (and storing) the global variables in the third section 64.

In this embodiment, a self-test (final production test upon assembly) is to be carried out. For this purpose, an event is generated by ATE equipment and signaled to the microcontroller 4 via interface 5. Further, the event is detected by the microcontroller 4 and is evaluated with the help of the software module kernel running on the microcontroller 4. In response to that specific event, the microcontroller 4 selects one or more program files from portion 106 of OTP area 10, which keeps the BIST algorithms. Thereby, binary code previously residing in the repository 6 may be overwritten by this or these program file(s).

Based on these newly stored program files in the repository 6, the microcontroller 4 continues to perform the self-test according to the binary code contained in the program files, i.e., the BIST algorithm. The code may further contain a sequence instructing the microcontroller 4 to gather and output the results of the self-test via interface 5 to the external ATE equipment.

Depending on the software module kernel, the microcontroller 4 may then return from a test mode to an operation mode, wherein a newly issued event signals the controller to load new program files from the memory array 8, or more precisely, the OTP area 10 into the program file section 62 of the repository 6, thereby overwriting the BIST program files.

In a preferred embodiment, permanent storage sections 64, 66 may be set to a state wherein the binary code content in these sections may be overwritten, for example in order perform an occasional firmware update. The same may be valid with respect to the portions 102-10n of the OTP area in order to include updates of the program files.

Having described some of the embodiments of the memory device and a method of controlling operation thereof, it is noted that modifications and variations can be made by persons skilled in the art in the light of the teachings as presented above. It is, therefore, to be understood that changes may be made in the particular embodiments of the invention disclosed, which are within the scope and spirit of the invention as defined by the appended claims. Having thus described the invention with the details and particularity required by the patent laws, what is claimed and desired protected by Letters Patent is set forth in the appended claims.

What is claimed is:

1. A method for controlling operation of a memory device, the memory device comprising a microcontroller, an error-tolerant repository arranged to store program files for execution by said microcontroller, and a memory array for storing data provided to the memory device externally, the method comprising:
receiving an event;
loading a first program file stored in said memory array into a first section of said repository in response to said event using said microcontroller; and
executing said first program file using said microcontroller in order to perform an operation of said memory device.

2. The method according to claim 1, further comprising executing a software module kernel stored in a second section of said error-tolerant repository using said microcontroller, prior to receiving said event.

3. The method according to claim 2, wherein the execution of said software module kernel is controlled by means of global variables that are stored in a third section of said error-tolerant repository and read out by said microcontroller.

4. The method according to claim 1, wherein the first program file is a built-in self-test program for performing a functional test of said memory device.

5. The method according to claim 1, wherein the first program file is a boot program for performing an initialization sequence upon startup of the device.

6. The method according to claim 2, wherein the receiving event is evaluated by said software module kernel executing in said microcontroller, and said first program file being loaded into said first section of said repository in response to said event is selected from a number of program files stored in said memory array in dependence of said evaluated received event.

7. The method according to claim 6, wherein a second event is received and evaluated by said microcontroller executing said software module kernel in order to load a second program file into said repository in response to said second event, wherein said first program file is deleted, unloaded or overwritten within said error-tolerant repository.

8. The method according to claim 6, wherein said event is generated internally or externally to the memory device.

9. A memory device, comprising:
a microcontroller for controlling operation of the memory device;
a memory array connected to the microcontroller for storing data that is received by the memory device from an external source; and
an error-tolerant repository connected to the microcontroller for storing program files to be executed by the microcontroller in order to perform testing, initialization or application of the memory device,
wherein the repository comprises a first section to be loaded with at least one first program file that can be deleted, unloaded or overwritten with at least one further program file by said microcontroller.

10. The memory device according to claim 9, wherein the memory array is a non-volatile memory.

11. The memory device according to claim 10, wherein the non-volatile memory is a flash memory.

12. The memory device according to claim 9, wherein the memory array comprises a one-time-programming area.

13. The memory device according to claim 12, wherein said one-time-programming area is arranged to permanently store the program files.

14. The memory device according to claim 13, wherein the error-tolerant repository further comprises a second section for storing a software module kernel, which is arranged to load said program files from said one-time-programming area into said first section or to delete, unload or overwrite said program files with further program files, when being executed by said microcontroller.

15. The memory device according to claim 14, wherein the second section for storing said software module kernel is arranged as a permanent storage area within said repository.

16. The memory device according to claim 14, wherein the error-tolerant repository further comprises a third section for storing global variables that are set to control execution of the software module kernel in said microcontroller.

17. The memory device according to claim 16, wherein the third section for storing global variables is arranged as a permanent storage area within said repository.

18. A memory device comprising:
a microcontroller;
a non-volatile memory array connected to the microcontroller, wherein the memory array comprises a first array section adapted to store external data, and a second array section adapted to store microcontroller program files; and
an error-tolerant repository connected to the microcontroller, wherein the repository comprises a first rewritable memory section adapted to load at least one of the program files from the second array section for execution by the microcontroller.

19. The memory device of claim 18, wherein the error-tolerant repository further comprises a second memory section containing a software module kernel adapted be executed by the microcontroller to control loading of the program files from the second array section into the first rewritable memory section.

20. The memory device of claim 19, wherein the error-tolerant repository further comprises a third memory section containing global variables for use by the microcontroller in executing the software module kernel.
